(19) United States
(12) Patent Application Publication
(10) Pub. No.: US 2008/0277225 A1
(43) Pub. Date: Nov. 13, 2008

(54) Three-pass torque converter with sealed piston and forced cooling flow

(75) Inventor: Patrick Lindemann, Wooster, OH (US)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 12/150,805

(22) Filed: May 1, 2008

Related U.S. Application Data
(60) Provisional application No. 60/928,437, filed on May 9, 2007.

(51) Int. Cl. F16D 33/00

(52) U.S. Cl. 192/3.28

(57) ABSTRACT

A torque converter assembly including a cover shell and a piston for a lock-up clutch. The piston is fixedly attached to the cover shell and the piston is flexible to operate the clutch. At least a portion of the piston at the point of attachment to the cover shell is in contact with the cover shell. The piston forms a portion of a sealed chamber and the piston is displaceable in response to fluid pressure in the chamber. In one embodiment, the attachment is made by projection welding proximate an inner diameter of the piston or by riveting proximate an inner diameter of the piston.

### CROSS-REFERENCE TO RELATED APPLICATIONS

This application claims the benefit under 35 U.S.C. §119(e) of U.S. Provisional Application No. 60/928,437 filed on May 9, 2007 which application is incorporated herein by reference.

### FIELD OF THE INVENTION

The invention relates generally to torque converters, and more specifically to a torque converter with a sealed piston and forced cooling flow.

### BACKGROUND OF THE INVENTION

FIG. 1 illustrates a general block diagram showing the relationship of the engine 7, torque converter 10, transmission 8, and differential/axle assembly 9 in a typical vehicle. It is well known that a torque converter is used to transmit torque from an engine to a transmission of a motor vehicle.

The three main components of the torque converter are the pump 37, turbine 38, and stator 39. The torque converter becomes a sealed chamber when the pump is welded to cover 11. The cover is connected to flexplate 41 which is, in turn, bolted to crankshaft 42 of engine 7. The cover can be connected to the flexplate using lugs or studs welded to the cover. The welded connection between the pump and cover transmits engine torque to the pump. Therefore, the pump always rotates at engine speed. The function of the pump is to use this rotational motion to propel the fluid radially outward and axially towards the turbine. Therefore, the pump is a centrifugal pump propelling fluid from a small radial inlet to a large radial outlet, increasing the energy in the fluid. Pressure to engage transmission clutches and the torque converter clutch is supplied by an additional pump in the transmission that is driven by the pump hub.

In torque converter 10 a fluid circuit is created by the pump (sometimes called an impeller), the turbine, and the stator (sometimes called a reactor). The fluid circuit allows the engine to continue rotating when the vehicle is stopped, and accelerate the vehicle when desired by a driver. The torque converter supplements engine torque through torque ratio, similar to a gear reduction. Torque ratio is the ratio of output torque to input torque. Torque ratio is highest at low or no turbine rotational speed (also called stall). Stall torque ratios are typically within a range of 1.8-2.2. This means that the output torque of the torque converter is 1.8-2.2 times greater than the input torque. Output speed, however, is much lower than input speed, because the turbine is connected to the output and it is not rotating, but the input is rotating at engine speed.

Turbine 38 uses the fluid energy it receives from pump 37 to propel the vehicle. Turbine shell 22 is connected to turbine hub 19. Turbine hub 19 uses a spline connection to transmit turbine torque to transmission input shaft 43. The input shaft is connected to the wheels of the vehicle through gears and shafts in transmission 8 and axle differential 9. The force of the fluid impacting the turbine blades is output from the turbine as torque. Axial thrust bearings 31 support the components from axial forces imparted by the fluid. When output torque is sufficient to overcome the inertia of the vehicle at rest, the vehicle begins to move.

After the fluid energy is converted to torque by the turbine, there is still some energy left in the fluid. The fluid exiting from small radial outlet 44 would ordinarily enter the pump in such a manner as to oppose the rotation of the pump. Stator 39 is used to redirect the fluid to help accelerate the pump, thereby increasing torque ratio. Stator 39 is connected to stator shaft 45 through one-way clutch 46. The stator shaft is connected to transmission housing 47 and does not rotate. One-way clutch 46 prevents stator 39 from rotating at low speed ratios (where the pump is spinning faster than the turbine). Fluid entering stator 39 from turbine outlet 44 is turned by stator blades 48 to enter pump 37 in the direction of rotation.

The blade inlet and exit angles, the pump and turbine shell shapes, and the overall diameter of the torque converter influence its performance. Design parameters include the torque ratio, efficiency, and ability of the torque converter to absorb engine torque without allowing the engine to “run away.” This occurs if the torque converter is too small and the pump can't slow the engine.

At low speed ratios, the torque converter works well to allow the engine to rotate while the vehicle is stationary, and to supplement engine torque for increased performance. At speed ratios less than 1, the torque converter is less than 100% efficient. The torque ratio of the torque converter gradually reduces from a high of about 1.8 to 2.2, to a torque ratio of about 1 as the turbine rotational speed approaches the pump rotational speed. The speed ratio when the torque ratio reaches 1 is called the coupling point. At this point, the fluid entering the stator no longer needs redirected, and the one way clutch in the stator allows it to rotate in the same direction as the pump and turbine. Because the stator is not redirecting the fluid, torque output from the torque converter is the same as torque input. The entire fluid circuit will rotate as a unit.

Peak torque converter efficiency is limited to 92-93% based on losses in the fluid. Therefore torque converter clutch 49 is employed to mechanically connect the torque converter input to the output, improving efficiency to 100%. Clutch piston plate 17 is hydraulically applied when commanded by the transmission controller. Piston plate 17 is sealed to turbine hub 19 at its inner diameter by o-ring 18 and to cover 11 at its outer diameter by friction material ring 51. These seals create a pressure chamber and force piston plate 17 into engagement with cover 11. This mechanical connection bypasses the torque converter fluid circuit.

The mechanical connection of torque converter clutch 49 transmits many more engine torsional fluctuations to the drivetrain. As the drivetrain is basically a spring-mass system, torsional fluctuations from the engine can excite natural frequencies of the system. A damper is employed to shift the drivetrain natural frequencies out of the driving range. The damper includes springs 15 in series with engine 7 and transmission 8 to lower the effective spring rate of the system, thereby lowering the natural frequency.

Torque converter clutch 49 generally comprises four components: piston plate 17, cover plates 12 and 16, springs 15, and flange 13. Cover plates 12 and 16 transmit torque from piston plate 17 to compression springs 15. Cover plate wings 52 are formed around springs 15 for axial retention. Torque from piston plate 17 is transmitted to cover plates 12 and 16 through a riveted connection. Cover plates 12 and 16 impart torque to compression springs 15 by contact with an edge of a spring window. Both cover plates work in combination to support the spring on both sides of the spring center axis. Spring force is transmitted to flange 13 by contact with a flange spring window edge. Sometimes the flange also has a rotational tab or slot which engages a portion of the cover plate to prevent over-compression of the springs during high torque events. Torque from flange 13 is transmitted to turbine hub 19 and into transmission input shaft 43.

Energy absorption can be accomplished through friction, sometimes called hysteresis, if desired. Hysteresis includes friction from windup and unwinding of the damper plates, so it is twice the actual friction torque. The hysteresis package generally consists of diaphragm (or Belleville) spring 14 which is placed between flange 13 and one of cover plates 16 to urge flange 13 into contact with the other cover plate 12. By controlling the amount of force exerted by diaphragm spring 14, the amount of friction torque can also be controlled. Typical hysteresis values are in the range of 10-30 Nm.

Prior art torque converters are designed to allow piston 17 to move axially relative to cover 11. Multiple plate torque converter clutch designs require an additional seal and additional apparatus for rotatably fixing piston 17 and cover 11. Additionally, the shells of prior art torque converters are welded together, allowing contamination to enter in the small gap created between the pump and cover. An additional lock-up plate may also be welded to the pump or cover shell, further increasing the risk of contamination. One such design can be seen in commonly assigned U.S. Provisional Patent Application No. 60/816,932, filed Jun. 28, 2006.

Also, stators in prior art torque converters are typically cast from aluminum. A stamped stator as described in commonly assigned U.S. patent application Ser. No. 11/728,066, filed Mar. 23, 2007, can be used to reduce cost and improve performance.

Thus there is a long-felt need for a piston plate which is directly engaged with the cover. There is also a need for a torque converter with a weld design and lock-up plate attachment method that reduce contamination. A need exists for a more durable stamped stator design with improved performance as well.

### BRIEF SUMMARY OF THE INVENTION

The present invention broadly comprises a torque converter assembly, including: a cover shell; a turbine hub; and a backing plate drivingly engaged with said cover. The backing plate extends radially proximate said turbine hub. In some aspects, said engagement is a press-fit spline connection. In some aspects, the torque converter includes a pump shell and said cover shell rests against a radial wall of a notched area in said pump shell.

The present invention also broadly comprises a torque converter assembly including a cover shell and a piston for a lock-up clutch. The piston is fixedly attached to the cover shell and the piston is flexible to operate the clutch. At least a portion of the piston at the point of attachment to the cover shell is in contact with the cover shell. The piston forms a portion of a sealed chamber and the piston is displaceable in response to fluid pressure in the chamber. In one embodiment, the attachment is made by projection welding proximate an inner diameter of the piston or by riveting proximate an inner diameter of the piston.

The present invention further broadly comprises a stamped stator assembly for a torque converter, with at least one sheet metal outer blade plate formed by stamping and at least one sheet metal inner blade plate formed by stamping. The outer and inner blade plates direct a fluid through said stamped stator assembly. In some aspects, a thickness of said inner blade plate is less than a thickness of said outer blade plate. In some aspects, the stamped stator includes a rivet and a one-way clutch. The rivet is installed to drivingly engage an outer race for said one-way clutch with said outer and inner blade plates. In some aspects, the at least one sheet metal outer plate includes a flanged area for positioning a bearing. In some aspects, said at least one outer blade plate extends radially inward to restrict axial movement of said one-way clutch. In some aspects, said piston is hydraulically sealed to said cover and to an input shaft for a transmission.

It is a general object of the present invention to provide a torque converter with for a piston plate which is directly engaged with the cover, a weld design and lock-up plate attachment method that reduce contamination, and a durable stamped stator design with improved performance.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a general block diagram illustration of power flow in a motor vehicle, intended to help explain the relationship and function of a torque converter in the drive train thereof;

FIG. 2 is a cross-sectional view of a prior art torque converter, shown secured to an engine of a motor vehicle;

FIG. 3 is a left view of the torque converter shown in FIG. 2, taken generally along line 3-3 in FIG. 2;

FIG. 4 is a cross-sectional view of the torque converter shown in FIGS. 2 and 3, taken generally along line 4-4 in FIG. 3;

FIG. 5 is a first exploded view of the torque converter shown in FIG. 2, as shown from the perspective of one viewing the exploded torque converter from the left;

FIG. 6 is a second exploded view of the torque converter shown in FIG. 2, as shown from the perspective of one viewing the exploded torque converter from the right;

FIG. 7A is a perspective view of a cylindrical coordinate system demonstrating spatial terminology used in the present application;

FIG. 7B is a perspective view of an object in the cylindrical coordinate system of FIG. 7A demonstrating spatial terminology used in the present application; and,

FIG. 8 is a cross-sectional view of a present invention torque converter.

### DETAILED DESCRIPTION OF THE INVENTION

At the outset, it should be appreciated that like drawing numbers on different drawing views identify identical, or functionally similar, structural element of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

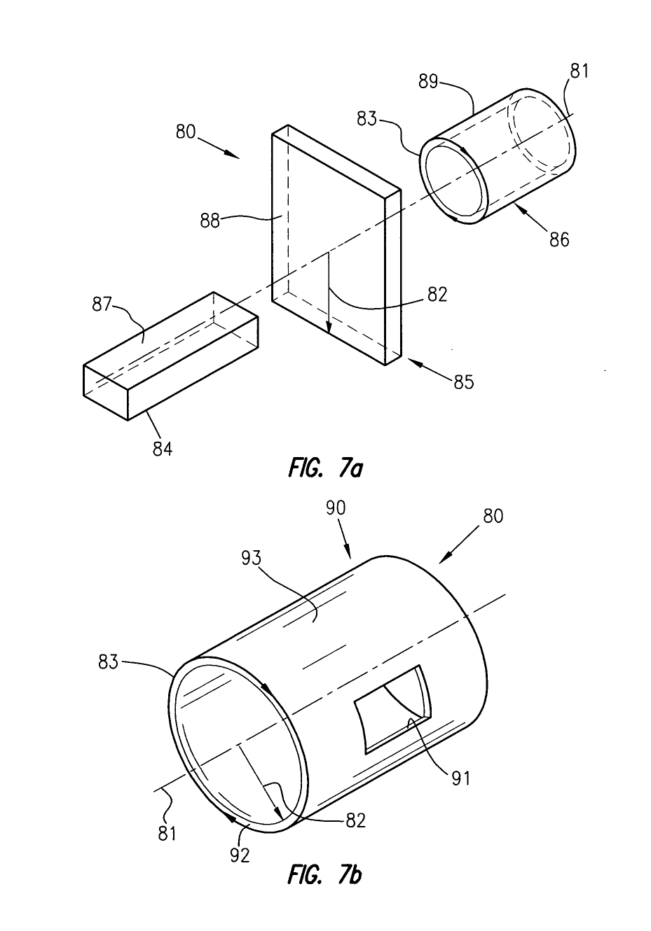

FIG. 7A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

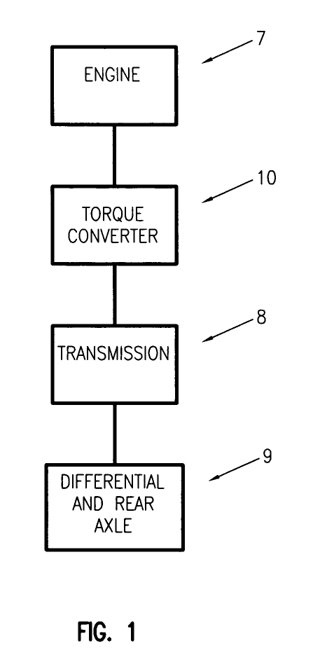

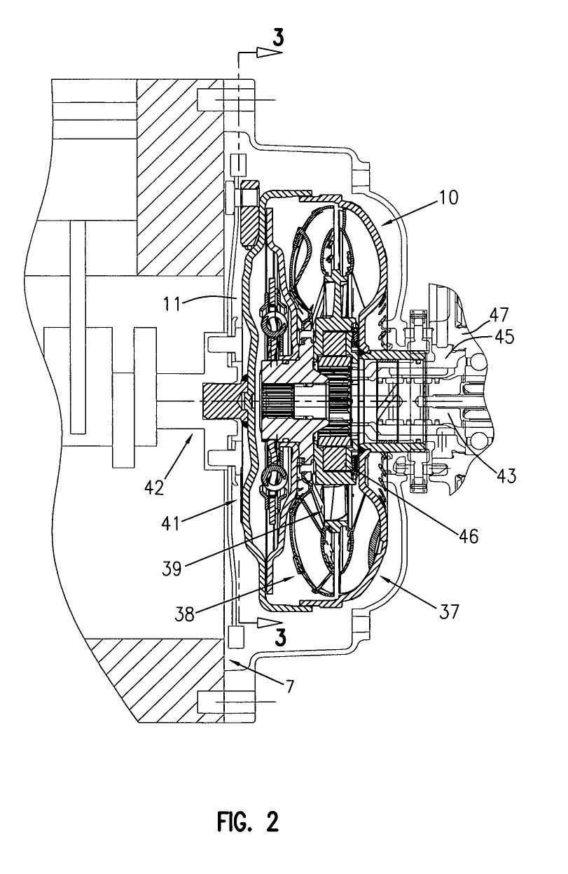

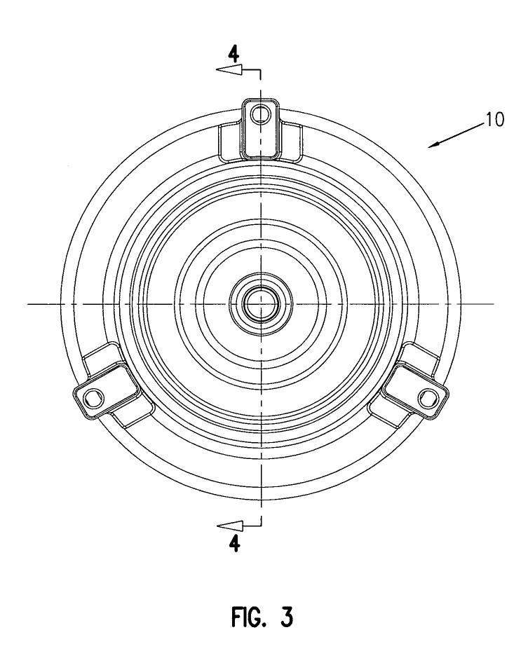

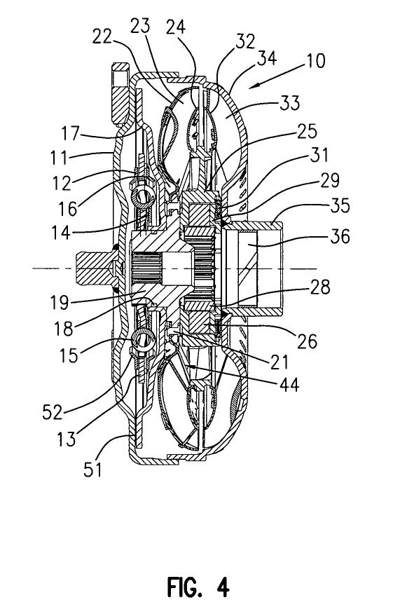

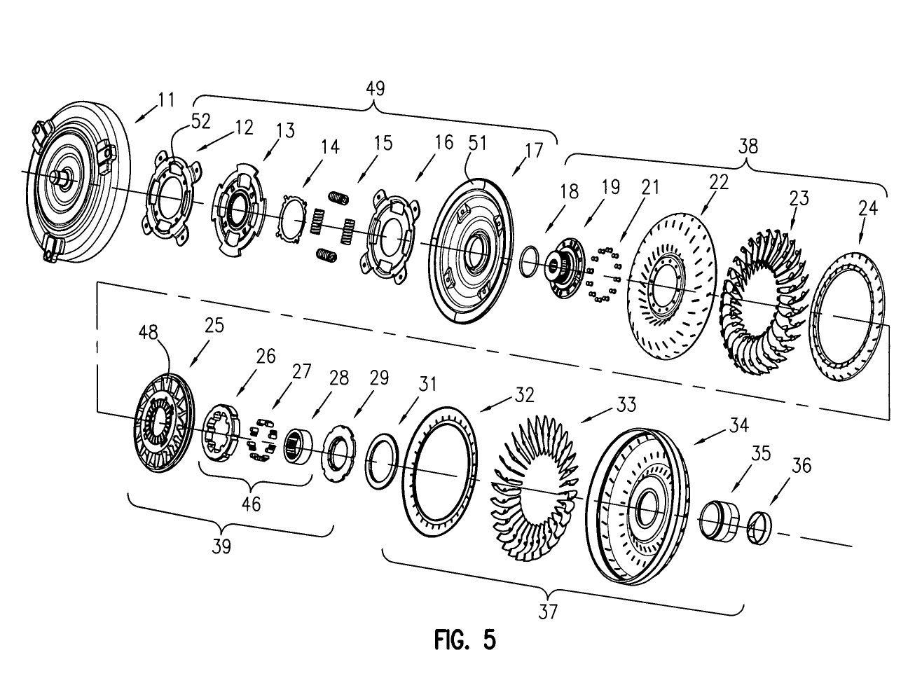

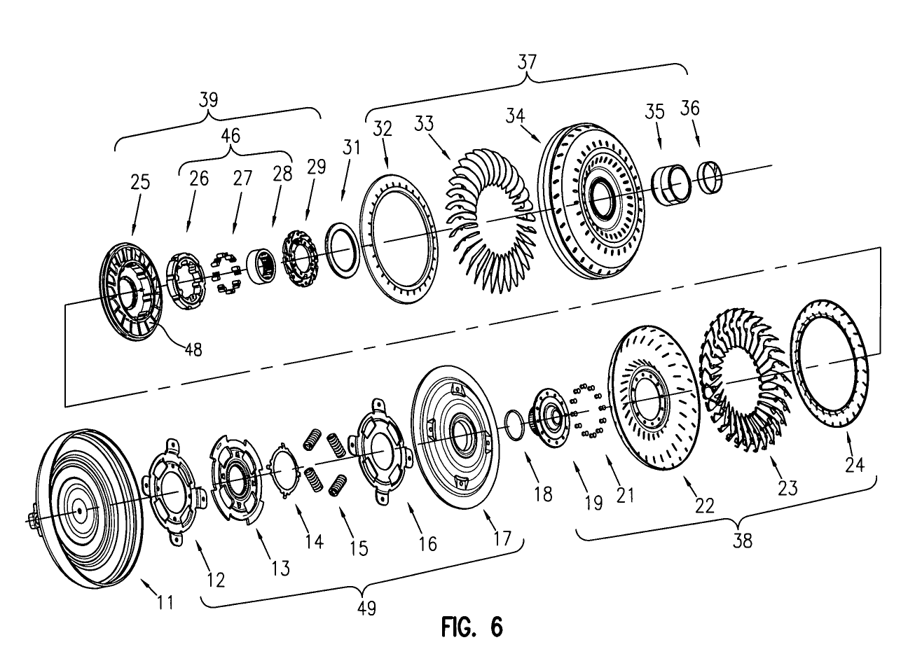

FIG. 7B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention is any manner. Object 90 includes axial surface 91, radial surface 92, and circumferential surface 93. Surface 91 is part of an axial plane, surface 92 is part of a radial plane, and surface 93 is part of a circumferential plane.

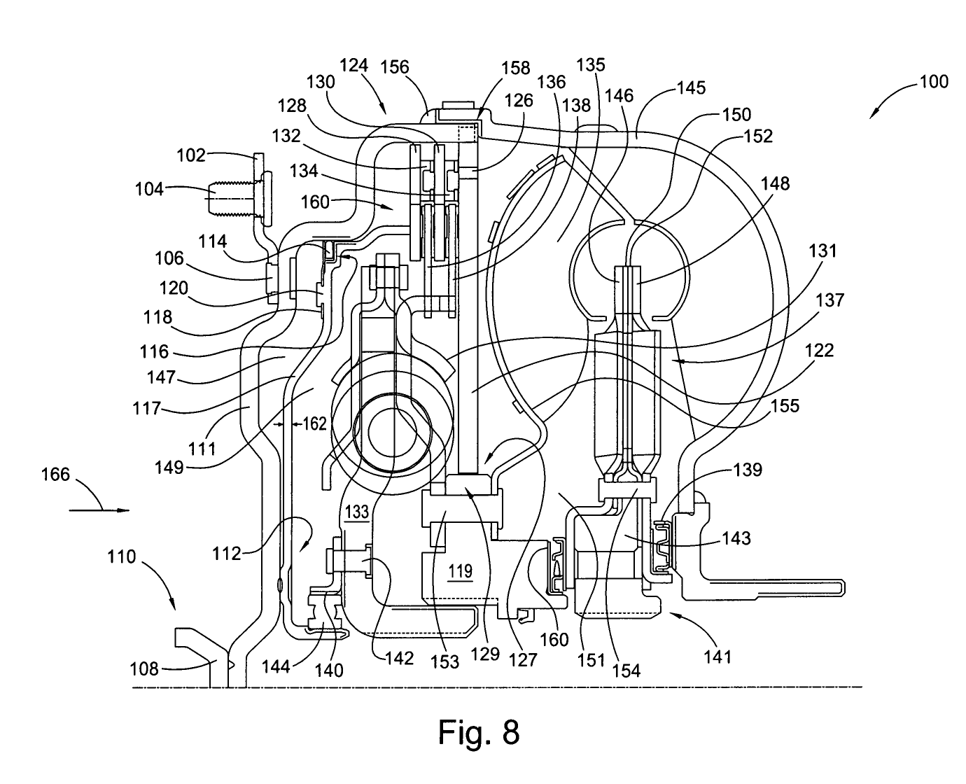

FIG. 8 is a cross-sectional view of present invention torque converter 100. Cover 111 is rotatably fixed to a flexplate (not shown) through drive plate 102 and stud 104. Drive plate 102 is fixed to cover 111 with extruded rivet 106. However, it should be understood that any means known in the art can be used to connect cover 111 to the flexplate. Pilot 108 centers cover 111 in a crankshaft (not shown). Pilot 108 is made of sheet metal and formed by stamping to reduce cost. In some aspects, end 110 of pilot 108 is radiused to allow pivoting of pilot 108 in the crankshaft. Pilot 108 is fixed to cover 111 using any means known in the art. In some aspects, pilot 108 is fixed to cover 111 by projection welding. In other aspects, pilot 108 is fixed to cover 111 by riveting (not shown). In some aspects, the pilot attachment rivet is an extruded rivet formed from cover 111.

Piston plate 117 is fixed to cover 111 at location 112, near the inner diameter of the cover. Piston plate 117 may be fixed to cover 111 using any means known in the art. In some aspects, piston plate 117 is fixed to cover 111 by projection welding. In other aspects, piston plate 117 is fixed to cover 111 by riveting (not shown). In some aspects, the piston attachment rivet is an extruded rivet formed from cover 111. Piston plate 117 is sealed to the input shaft at its inner diameter (not shown). Piston plate 117 is further sealed to cover 111 with seal 114 positioned in coined area 116 of piston 117, and retained by retainer plate 118. Retainer plate 118 may be attached to piston 117 using any means known in the art. In some aspects, retainer plate 118 is attached to piston 117 with extruded rivets 120. In some aspects, seal 114 is a dynamic seal.

In a preferred embodiment, at least a portion of the piston at the point of attachment to the cover shell is in contact with the cover shell. The piston plate is flexible radially beyond the attachment point to the shell to operate lock-up clutch 160. The piston plate also forms part of sealed chamber 162 and is displaceable in response to fluid pressure in the chamber to control the operation of the lock-up clutch. For example, when the force on the piston plate from fluid pressure in chamber 162 is greater than the force on the piston plate from fluid in chamber 164, the piston displaces in direction 166 to engage the clutch.

The direct connection of the piston to the cover can replace other methods of connecting the piston and the cover, such as splines or leaf springs. Advantageously, the direct connection does not rattle as does a spline connection. Also advantageously, the specially tooling and extra steps needed to reach rivets or fasteners for the leaf springs from the back side are eliminated by the direct connection.

Backing plate 122 is substantially planar and extends radially in from cover outer circumference 124. Backing plate 122 may be fixed to cover outer diameter 124 using any means known in the art. In some aspects, backing plate 122 is fixed to cover outer diameter 124 using a press-fit toothed connection, thereby eliminating rattle. Orifice 126 allows cooling flow to pass through backing plate 122. In some aspects, inner circumference 127 of backing plate 122 has minimal clearance to outer circumference 129 of turbine hub 119 to limit flow. In other aspects, backing plate 122 is sealed to turbine hub 119 with a dynamic seal (not shown).

Separator plates 128 and 130 are rotatably fixed to backing plate 122 with leaf springs 132 and 134, respectively. In some aspects, leaf springs 132 and 134 are fixed using extruded rivets. Friction plates 136 and 138 are rotatably engaged with cover plate 131. In some aspects, plates 136 and 138 are engaged with cover plate 131 with a spline connection.

Centering flange 140 is fixed to flange 133 using any means known in the art. In some aspects, centering flange 140 is riveted to flange 133 using rivet 142. Bearing 144 positions centering flange 140 relative to piston plate 117, thereby centering turbine assembly 135 through tight fit between flange 133 and turbine hub 119.

Stator 137 is an assembly of stamped components. Outer plates 146 and 148 on either side contain support plates 150 and 152. In some aspects, support plates 150 and 152 are thinner than outer plates 146 and 148 to accommodate forming and to enhance performance of the stator. Although a specific number of outer plates and support plates are shown, any number of plates and support plates are within the scope of the invention. In some aspects, outer plate 148 has a flanged area to position bearing 139. In other aspects (not shown), outer plate 148 has a positioning flange. In some aspects, outer plates 146 and 148 retain internal components of one-way clutch assembly 141.

Outer race 143 of one-way clutch assembly 141 is rotatably fixed to plates 146, 148, 150, and 152 using any means known in the art. In some aspects, rivets 154 are used to fix plates 146, 148, 150, and 152 to outer race 26.

Cover shell 111 and pump shell 145 create a sealed vessel when joined with weld 156. In some aspects, cover shell 111 extends axially into pump shell 145 until it contacts stepped area 158. The solid stop design of the cover-pump interface reduces the possibility of contamination entering torque converter 100 during welding. In some aspects, thickness of washer 160 is selected to ensure proper clearance of internal components when cover 111 is engaged with pump shell stepped area 158.

Chamber 147 is located between cover 111 and piston 117. Chamber 149 is located between piston 117 and sealing plate 122. Chamber 151 is located between sealing plate 122 and pump shell 145. Each chamber is charged with transmission oil through its own path from the transmission. This is referred to as a three-pass hydraulic system.

During operation in torque converter mode, pressure in chamber 147 is lower than pressure in chamber 149. Therefore, piston plate 117 is pushed towards cover 111 and friction plates 136 and 138 do not transmit torque. Oil flows from chamber 149 through orifice 126 into chamber 151 to cool torque converter 100.

When torque converter clutch mode is desired, pressure in chamber 147 is increased so that piston 117 is urged towards backing plate 122, clamping friction plates 136 and 138 which transmit torque to cover plate 131. Because piston 117 is fixed to cover 111, the piston must deflect. In some aspects, thickness 162 of the piston is varied to allow necessary deflection while keeping stress low for improved durability. Oil flows from chamber 149 through friction plates 136 and 138, through orifice 126, and into chamber 151 to cool friction plates 136 and 138. Some oil may leak between backing plate 122 and turbine hub 119 if they are not sealed together.

Rivet 153 connecting turbine shell 155, turbine hub 119, and cover plate 131 advantageously eliminates rattle.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What I claim is:

1. A torque converter assembly, comprising:
a cover shell; and,
a piston for a lock-up clutch, wherein the piston is fixedly attached to the cover shell and wherein the piston is flexible to operate the clutch.

2. The torque converter assembly of claim 1 wherein at least a portion of the piston at the point of attachment to the cover shell is in contact with the cover shell.

3. The torque converter assembly of claim 1 wherein the piston forms a portion of a sealed chamber and the piston is displaceable in response to fluid pressure in the chamber.

4. The torque converter assembly of claim 1 wherein the attachment is made by projection welding proximate an inner diameter of the piston.

5. The torque converter assembly of claim 1 wherein the attachment is made by riveting proximate an inner diameter of the piston.
